(19) United States
(12) Patent Application Publication
(10) Pub. No.: US 2002/0089430 A1
(43) Pub. Date: Jul. 11, 2002

(54) Passive keyboard for digital computer

(75) Inventors: Netzer Moriya, Ramat Hasharon (IL); Dov Shlomo Eylath, Ramat Gan (IL); David Gidron, Hod Hasharon (IL)

Correspondence Address: FITCH EVEN TABIN AND FLANNERY, 120 SOUTH LA SALLE STREET, SUITE 1600, CHICAGO, IL, 60603-3406, US

(73) Assignee: NETMOR LTD.

(21) Appl. No.: 09/880,278

(22) Filed: Jun. 13, 2001

(30) Foreign Application Priority Data
Jun. 15, 2000 (IL) 136806

(51) Int. Cl. H03M 11/00; H03K 17/94

(52) U.S. Cl. 340/870.16; 341/22

(57) ABSTRACT

A three-dimensional position fixing system associated with the keyboard of a digital computer, the keyboard being provided with an array of passive keys which identify the numerals, letters, symbols and other values to be entered in binary code forms into the computer when the keys are touched by a finger of the operator. The system includes a responder mounted on the operator's finger and a transmitter-receiver assembly housed in the computer which cooperates with the responder to yield a signal indicative of the exact position of the finger when touching a particular key. Digitally stored in the data storage of the computer is a table listing the keyboard location of each key and the binary codes of the values identified by the keys. In operation, when an operator touches a particular key with his finger, the resultant signal indicative of the finger position acts to scan the table to select therefrom the key whose location matches the finger position, and then extracts the related binary code which is entered into the computer.

### BACKGROUND OF THE INVENTION

1. Field of the Invention

This invention relates generally to keyboards for digital computers, and in particular to a passive keyboard associated with a position-fixing system in which a responder mounted on a finger of the operator cooperates with a transmitter-receiver assembly installed in the computer to produce a signal indicative of the position of the finger on the keyboard.

2. Status of Prior Art

Laptop computers and other compact digital computers are provided with a keyboard having an array of depressible keys identifying the numerals, alphabet letters, symbols and other values to be entered digitally into the computer for processing therein.

When operating a computer keyboard. it is essential that the finger of the operator engage a particular key, and that it not at the same time actuate an adjacent key, for should this occur, then a false entry will be made in the computer.

The current trend toward computer miniaturization has resulted in a reduction in the scale of the keyboard. This makes it increasingly difficult for an operator to properly manipulate the keys with his fingers.

In a conventional keyboard, the key has a face whose area is large enough to easily encompass the finger tip of the operator, even one that is thick. But when the keyboard is reduced in scale, the area on the face of each key is barely sufficient to accommodate this fingertip. As a consequence, it becomes difficult for a typical operator, especially one working at high speed, to avoid depressing with his finger more than one key at a time.

When a key on the keyboard is fully depressed, there is then generated by this action the binary code representing the numeral, alphabet letter, symbol or other value identified by the key. Should the key be only partially depressed, the appropriate code will not be generated.

When the computer keyboard is placed on a stable surface, such as the top of a desk, there is no problem in fully depressing each key, even when working at high speed. But when the computer rests in the lap of its operator or on any other unsteady surface, then the operator may experience difficulty in fully depressing the keys in all instances.

A keyboard in accordance with the present invention is passive in the sense that its keys occupy fixed positions and are actuated only when touched by the operator's fingertip, whether the touch is light or heavy. To effect such actuation, the keyboard is associated with a three-dimensional position-determining system which includes a responder that is mounted on the operator's finger and cooperates with a transmitter-receiver installed in the computer. The system functions to fix the exact location of the finger touching the keyboard, hence the location of the key touched by the finger.

Of prior art interest therefore are patents disclosing a system for determining the exact location of a moving object or target, one such patent being U.S. Pat. No. 5,982,480 (1992) to Itzkovich et al. In this patent, the location of the object is determined in terms of Cartesian coordinates, namely its position with respect to mutually-perpendicular X, Y and Z axes passing through a moving object.

In the Itzkovich system, in order to determine in real time the three-dimensional position of a moving target in terns of Cartesian coordinates, a responder is mounted on the target which cooperates with three ground transmitter-receiver stations placed at known Cartesian coordinate sites. Transmitted from each station is a primary-intensity-modulated light signal which is intercepted by the responder on the moving target. The responder then transmits a secondary intensity-modulated light signal which is intercepted by the receiver at the ground station. The exact position of the target in Cartesian terms is determined by analyzing the outputs of the receivers and the ground stations.

Also known in the field of position determination as applied to aircraft is the use of a transponder mounted on a plane which picks up a radar frequency signal transmitted from a transceiver at a ground station and in response thereto transmits distinctive signals which are picked up by the receiver at the ground station.

In U.S. Pat. Nos. 4,314,251; 4,743,356; 4,849,692 and 5,646,525 there are disclosed positioning-determining systems in which a plurality of transmitters generating electromagnetic fields cooperate with a transducer mounted on a moving target

### SUMMARY OF THE INVENTION

In view of the foregoing the main object of the invention is to provide a passive keyboard for a digital computer associated with a position-fixing system which make it possible for an operator simply by finger touching the keys to enter into the computer the codes relating to the numerals, alphabet letters, symbols and other values identified by the keys. Note that by touching, as this term is used herein, is meant not only physical contact, but also close proximity to the keys.

More particularly, an object of this invention is to provide an arrangement of the above type in which a responder mounted on a finger of the operator cooperates with a transmitter-receiver assembly installed in the computer to fix the exact three-dimensional position of the key then touched by the finger.

A system in accordance with the invention has many advantages, among which are the following:

A. The system makes it possible to reduce the scale of the computer keyboard without making it more difficult for an operator to use the keyboard.

B. The system makes it easier for an operator to actuate the keys of the keyboard, for it is only necessary that a finger of the operator touch the keys with any degree of pressure, for the system is sensitive only to the position of the fingertip at its point of contact with a key, not with the pressure applied thereto.

C. Touch-actuation of the passive keys of the keyboard facilitates high-speed operation of the keyboard, in that at the instant the fingertip touches the face of the key, the binary code related to the identification of the key is entered into the computer.

D. Because the keys are passive and not depressible, only one key can be actuated at a time, thereby obviating false entries resulting from the concurrent actuation of adjacent keys.

Briefly stated, these objects are attained in a three-dimensional position fixing system associated with the keyboard of a digital computer, the keyboard being provided with an array of passive keys which identify the numerals, letters, symbols and other values to be entered in binary code forms into the computer when the keys are touched by a finger of the operator.

The system includes a responder mounted on the operator's finger and a transmitter-receiver assembly enclosed in the computer which cooperates with the responder to yield a signal indicative of the exact position of the finger when touching a particular key. Digitally stored in the data storage of the computer is a table listing the keyboard location of each key and the binary codes of the values identified by the keys. In operation, when an operator touches a particular key with his finger, the resultant signal indicative of the finger position acts to scan the table to select therefrom the key whose location matches the finger position, and then extracts the related binary code which is entered into the computer.

### BRIEF DESCRIPTION OF THE DRAWINGS

For a better understanding of the invention as well as other objects and features thereof, reference is made to the annexed drawings wherein:

FIG. 1 is a block diagram of a digital computer provided with a passive keyboard in accordance with the invention;

FIG. 2 illustrates the relationship between the finger of an operator and a key on the keyboard shown in FIG. 1; and

FIG. 3 is a block diagram of a position fixing system in accordance with the invention in which a responder mounting on a finger of the keyboard operator cooperates with a transmitter-receiver assembly installed in the computer.

FIG. 4 is a flowchart of the logic to be applied for operating a digital computer in accordance with invention

### DETAILED DESCRIPTION OF A PREFERRED EMBODIMENT

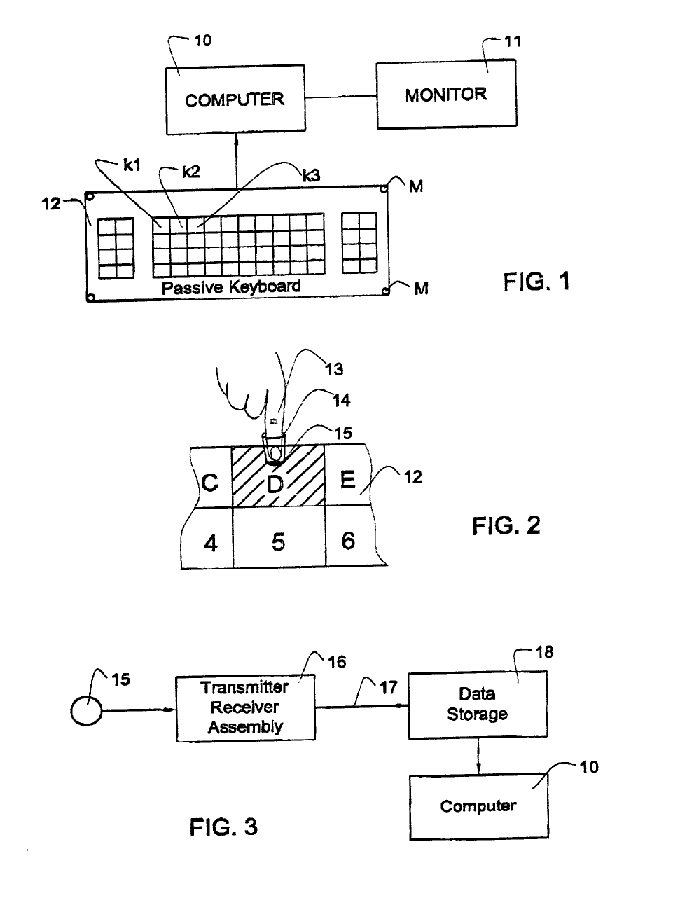

Referring now to FIG. 1 shown therein is a conventional digital computer 10 having a central processing unit for processing digital data entered into the computer. Computer 10 which may be a laptop or other compact computer is provided with a monitor 11 on whose screen is exhibited the data being processed. Digital data is entered into the computer by a passive keyboard 12 in accordance with the invention. It is to be understood that the invention is not limited only to computers, but may be also applicable to any keyboard operated electronic device, such as cellular phones, personal digital administrators (PDA), etc.

Keyboard 12 comprises an array of individual keys k₁, k₂, k₃, etc., each key identifying a particular numeral, alphabet letter, symbol or other value to be entered into and processed by the computer.

In a conventional keyboard, the keys are depressible by a finger of the operator, this action resulting in the generation of the binary code related to the key identification. When, therefore, the operator depresses the keys to enter into the computer the values, for instance, 5+3, then the entries into the computer are the binary codes for 5, plus, and 3. And exhibited on the screen of the monitor will be 5+3=8. But this can happen only if the operator, when depressing a selected key with his finger, does not bridge an adjacent key and also depresses that key, thereby making a false entry into the computer. One has to bear in mind that the invention is not limited to the use of binary codes, but it is applicable to any digital code, such as barcodes, etc.

Keyboard 12 is passive, for its keys k₁, k₂, k₃, etc., are not depressible but, for example, are graphically imprinted or otherwise impressed on the planar surface of a rectangular paper sheet or plastic plate. Any key in the array of keys presented by the plate can be actuated simply by touching it with a fingertip, the point of contact lying within the boundaries of the area on the face of the key.

To this end, as shown in FIG. 2, the fingertip 13 on the index finger of the operator is inserted in a thimble 14 in whose rounded head is placed a miniature responder 15. The thimble is made of plastic or other material that is permeable to the electromagnetic or other signals to be intercepted by the responder. Because the head of the thimble is rounded, it is only the tip thereof that touches the surface of the keyboard.

As shown in FIG. 3, responder 15 cooperates with a transmitter-receiver assembly 16 whose output signal 17 is indicative of the exact position of responder 15, hence the position of the particular key being touched by the fingertip of the operator. Responder 15 in conjunction with the transmitter-receiver assembly constitutes a three-dimensional position determining system of any known type.

Output signal 17 of the transmitter-receiver assembly 16 is indicative in terms of the Cartesian X-Y-Z coordinates of the exact position of the responder mounted on the finger touching a key and therefore is indicative of the key position. Output signal 17 is fed into a data memory storage 18 associated with computer 10 to supply the computer with the binary codes of the numerals and other values identified by the keys of the keyboard. Those versed in the art should readily appreciate that where the keyboard has a fixed position with respect to the transducer receiver assembly, then for determination of the position of the key on the keyboard it is only necessary to determine the Cartesian X-Y coordinates of the responder.

Where applicable, other technique for determination of the position of the responder mounted on the finger touching a key may be utilized. In particular, output signal 17 of the transmitter-receiver assembly 16 may not be indicative only in terms of the Cartesian X-Y-Z coordinates, but may be expressed in orientational coordinates, such as spherical, cylindrical, etc.

Stored digitally in data storage 18 is a table listing the respective locations of the keyboard keys and their related binary codes. In effect, stored in the data storage is a virtual map of the keyboard, the location of each key on the map being listed. In operation, this table is scanned to find the key whose location matches the location indicated by signal 17, When a match is found, the binary code related to the key is extracted from the data storage and entered into the computer for processing therein.

When the passive keyboard is printed on a paper sheet that is put to use only when the computer is to be operated, then it becomes necessary at the outset of operation that the computer be advised as to the spatial position of the paper keyboard relative to the transmitter-receiver assembly to thereon. To this end, the comers of the sheet have printed thereon markers M. The operator by touching these markers then produces signals indicative of the spatial position of the keyboard.

In a system in accordance with the invention which requires that a match be found between the location of the responder on the finger with the key location listed in the data storage table, the arrangement must be such as to provide tolerance. That is to say, when the location of a touched key is indicated by signal 17, a match will then be found if the location of the touched key, as indicated by signal 17, is plus or minus a few percent of the listed location. In one embodiment of the system, an LED light indicator may be included, which is switched on only when a key is properly actuated.

While there has been shown a preferred embodiment of a passive keyboard associated with a position determining system, it is to be understood that many changes may be made therein without departing from the spirit of the invention. Thus, instead of a thimble, the responder may be incorporated in a ring that goes over the nail of the finger, thereby exposing the fingertip so that it directly engages the key. Further, while the invention has been described herein with respect to one finger operation, it is likewise applicable to operation with more than one finger.

It is important to understand that the invention is not limited to a keyboard for a digital computer associated with a position-fixing system in which a sensor or responder mounted on a finger of the operator cooperates with a transmitter-receiver to produce a signal indicative of the position of the finger on the keyboard.

The concept underlying the invention is applicable to other situations not involving the generation of a code when a key is touched, nor requiring that the key be touched by a finger of the operator. Thus the operator may be physically impaired and be capable only of moving his legs, in which case the responder can be mounted on a toe of the operator's body, or on any other body member the operator is capable of moving.

For example, the operator can be an impaired patient confined to a hospital bed who is capable only of moving his legs, the responder in this case being attached to a toe of the patient. And in this case, the keyboard which must be accessible to the toe can simply printed on a sheet of paper attached to the footboard on the bed, or it can be drawn directly on the footboard. The keys of the keyboard are numbered to identify different hospital services. Thus number 10 could be a call for a nurse, number 12 a call for drinking water, and number 13 a call for a doctor.

The electronic device associated with the keyboard is adapted to initiate the actions required by the keys. Thus if key 10 is touched by the toe of the operator, the device then signals the nurse's station that the patient in bed X in room Y is calling for a nurse.

For the electronic device to function properly when a key is activated, it must not only be informed of the position of the member touching the key but it must also be informed of the position of the keyboard. To this end, the passive paper keyboard is provided with markers at its corners, as previously described, whose positions are sensed to establish the spatial position of the rectangular sheet. The keys may each carry a marker to inform the electronic device of the key positions so as to create a virtual map of the keyboard. In all other respects, the operation of this electronic device keyboard arrangement is the same as that of the computer arrangement previously described.

Also instead of mounting a sensor on a finger, in practice, the sensor may be incorporated in a glove worn by the operator. And the glove may include a sensor for each finger, for multi-finger activation of the keys.

In accordance with another aspect of the invention, there is provided a technique which makes it possible for an operator, simply by moving a finger or any other movable member of his body, to enter into the computer the codes relating to a symbol. The term symbol herein construed in a broad manner encompassing numerals, alphabet letters, and other values.

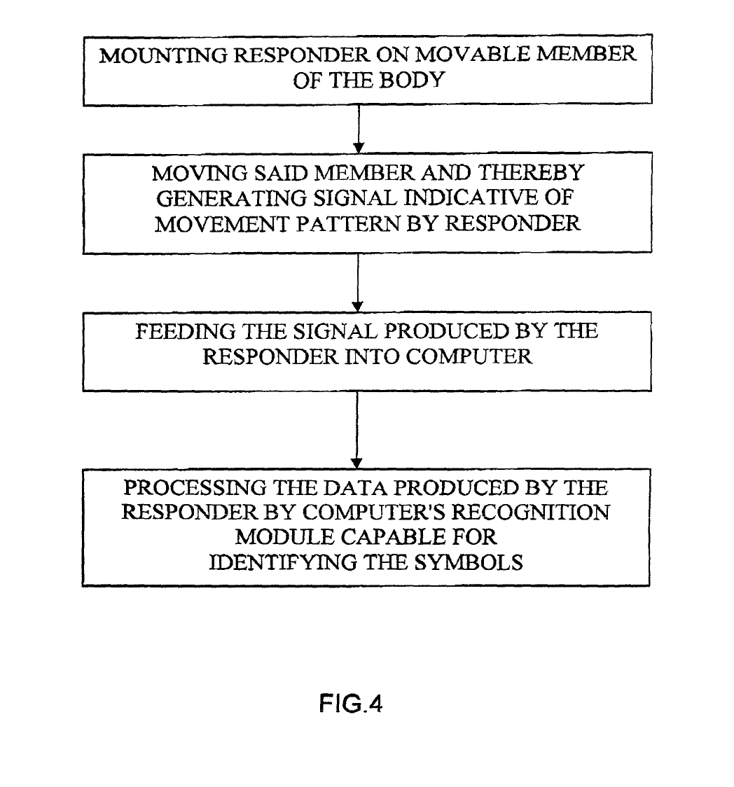

A system in accordance with this aspect of the invention does not have a keyboard at all. FIG. 4 refers to a method for operating a digital computer in accordance with this aspect of the invention. A responder is mounted on a finger or any other movable member of the operator, and cooperates with a transmitter-receiver assembly installed in the computer. The operator, by moving his member of the body, may simply draw, for example, a contour of letters, numerals, etc., in other words, to create a movement pattern. As a result of this movement, the responder will generate a signal indicative of the movement pattern.

Thereafter, the signal is fed into the computer for processing by a recognition module. The recognition module is operated by software known per se, which is capable to identify the symbol from its movement pattern. For example, such known software may be Optic Character Recognizer (OCR) software used in PDA, such as Palm III™ device.

For example, the operator can be an impaired patient of the aforementioned example, who is capable only of moving his legs, the responder in this case being attached to a toe of the patient. And in this case, the patient may draw a number identifying a special hospital service by moving his toe, and thereby initiate the actions of the service associated with this number.

While in the specification we referred to particular systems, it is to be understood that any known systems of this type, such as optical systems, magnetic systems, infrared systems, ultrasonic systems, etc, may be usable in association with the responder mounted on the finger or any other movable member of the body.

1. A method for operating the keyboard of a digital computer or other electric device by touching the keys with a fingertip of an operator, which keys identify numerals, letters and other values to be entered digitally into the computer and processed therein; said method comprising the steps of:
A. mounting a responder on the operator's finger;
B. determining by transmitter-receiver means associated with the computer and cooperating with the responder the exact position of the key on the keyboard that is touched by the fingertip of the operator to produce a signal indicative thereof; and
C. applying the signal to a data storage associated with the computer in which is digitally stored a table listing the location of each key and the binary code related thereto, the signal scanning the table to select therefrom the key whose location matches the location indicated by the signal, whereby the binary code related to the selected key is then generated.

2. A method as set forth in claim 1 in which the responder is placed in a thimble into which the fingertip is insertable.

3. An arrangement for operating a passive keyboard of a digital computer or other electric device by touching its keys with a finger, the keys identifying numerals, letters and other values to be entered into the computer for processing therein, said arrangement comprising:
A. a responder mounted on said finger;
B. a transmitter-receiver assembly associated with the computer and cooperating with said responder to produce a signal indicative of the location of the key touched by the finger on which the responder is mounted;
C. a data storage included in the computer having digitally stored therein a scanable list of the respective locations of the keys of the keyboard and the binary code related to each key;
D. and the computer configured to apply said signal to said data storage to effect a scanning action to select from the table the key whose location matches the location indicated by the signal whereby the binary code for that key is then entered into the computer.

4. An arrangement as set forth in claim 3 in which the keyboard has a planar surface on which is impressed an array of said keys.

5. An arrangement as set forth in claim 3 in which the responder is placed within a thimble into which is insertable the tip of the finger.

6. An arrangement as set forth in claim 4 in which the face of each key has a relatively small area, which is sufficient to encompass the tip of the finger.

7. An arrangement as set forth in claim 6 in which the faces of the keys are closely adjacent each other.

8. An arrangement as set forth in claim 1 in which a primary signal transmitted by the transmitter is intercepted by the responder and in response thereto, the responder transmits a secondary signal which is intercepted by the receiver.

9. An arrangement as set forth in claim 8 in which the exact position of the responder is determined in terms of Cartesian X-Y-Z coordinates.

10. An arrangement as set forth in claim 8 in which the exact position of the responder is determined in terms of spherical coordinates.

11. An arrangement as set forth in claim 8 in which the exact position of the responder is determined in terms of cylindrical coordinates.

12. A method by which an individual having a movable member can operate a keyboard whose keys have indicia identifying respective actions that can be taken by an electronic device activated by the keyboard, said method comprising the steps of:
A. mounting a responder on the operator's member;
B. determining by transmitter-receiver means associated with the electronic device and cooperating with the responder the exact position of the key on the keyboard that is touched by the member of the operator to produce a signal indicative thereof; and
C. applying the signal to a data storage associated with the electronic device in which is digitally stored a table listing the location of each key and the action related thereto, the signal scanning the table to select therefrom the key whose location matches the location indicated by the signal, whereby the action related to the selected key is then initiated.

13. A method for operating a digital computer by creating a movement pattern indicative of symbols to be entered digitally into the computer and processed therein by an operator having at least one movable member; said method comprising the steps of:
A. mounting a responder on said member;
B. moving said member and thereby generating a signal indicative of said movement pattern by the responder;
C. feeding the signal produced by the responder into the computer;
D. processing the data produced by the responder by a recognition module capable of identifying said symbols.

14. A method as set forth in claim 13 in which the movable member is a fingertip and the responder is placed in a thimble into which the fingertip is insertable.

15. A method as set forth in claim 13 in which the movable member is a toe.
